(19) United States
(12) Patent Application Publication
(10) Pub. No.: US 2019/0097940 A1
(43) Pub. Date: Mar. 28, 2019

(54) NETWORK SYSTEM AND METHOD FOR CROSS REGION VIRTUAL PRIVATE NETWORK PEERING

(71) Applicant: Alibaba Group Holding Limited, Grand Cayman, KY (US)

(72) Inventors: Gang Cheng, Bellevue, WA (US); Wei Zhao, Bellevue, WA (US); Shumin Zhu, Hangzhou (CN); Jiesheng Wu, Redmond, WA (US); Rong Wen, Hangzhou (CN)

(21) Appl. No.: 15/113,806

(22) PCT Filed: Jun. 15, 2016
(86) PCT No.: PCT/CN2016/085849

§ 371 Date: Jul. 22, 2016

(30) Foreign Application Priority Data
Jun. 15, 2016 (CN) PCT/CN2016/085849

(51) Int. Cl. H04L 12/913; H04L 12/66; H04L 12/46; H04L 12/781

(52) U.S. Cl. CPC H04L 47/724; H04L 45/52; H04L 12/4641; H04L 12/66

(57) ABSTRACT

A networking method includes a step of receiving, at a first gateway hardware group, a data communication from a virtual machine (“VM”) in a first virtual private cloud (“VPC”). The data communication includes routing information for transmitting the data communication to a VM in a second VPC. The data communication is transmitted from the first gateway hardware group to a second gateway hardware group via a connection line having a globally unique identification (“ID”) assigned thereto. The second gateway hardware group is distinct from the first gateway hardware group. A portion of a total network traffic capacity of the connection line is reserved for exclusive use of data transmissions being routed from the first VPC to the second VPC. The data communication is routed from the second gateway hardware group to the second VPC.

### RELATED APPLICATION(S)

The instant application is related to U.S. application Ser. No. 15/005,613, which application is incorporated in its entirety herein by reference.

### BACKGROUND

As companies and corporations grow, one of the most challenging aspects of modern business is effective management of the ever-changing technology scene. This aspect of management may be affected by the changes in at least three ways.

First, computing and software advancements are accelerating at a rapid rate. These advancements often provide more convenience to users, increased speed of transactions and processes, and greater effectiveness of business related functions generally. As such, to have any of the aforementioned benefits would be valuable to almost any business that wants to succeed because that is what the customer expects and it is in the business' best interest to try to fulfill that expectation. Further, a user may have a personal interest in access to advanced or remotely available technology and services. Unfortunately, while these benefits may appear appealing to the end-users, the benefits also come with an increase in cost. Cutting-edge technology tends to be available for a premium price, which may not be readily attainable for many end-users to implement, particularly on a frequently revolving basis, due to the sheer quantity of technological products an end-user need to purchase if all of a user's current tech hardware constantly requires upgrades to achieve the advanced technology.

Second, the business workplace scene for employees and employers alike is changing in the manner that the technology is being used. In particular, the “workplace” is more frequently becoming located in multiple and diverse places including the employee's home, vacation destination, hotel room during business travel, transportation means between home and the office, etc. Essentially, markets for a business' products or services are expanding between nations far and near. Moreover, the end-user employees are seeking additional benefits, access, and convenience from their workplaces. Thus, the end-users of the technology need access to business information whenever and wherever they are around the world.

Third, as businesses expand to faraway markets and end-users need remote access, the dependability and security of a localized, in-house private network is lost. Thus, the reliability of securely and timely accessing business information across a massive network becomes an increasingly important aspect of maintaining a quality business.

Accordingly, in an effort to address the issues discussed above, many businesses are turning from in-house IT to Virtual Private Cloud (VPC) networks. A VPC has been described as an external IT resource of an on demand configurable pool of shared computing resources allocated within a public cloud environment. These VPCs attempt to provide a certain level of isolation between the different businesses or organizations using the resources. As such, instead of individual businesses needing to constantly update internal resources or pay additional employees to maintain expensive new equipment, the burden may be shifted in part to the host of the VPC and shared by many businesses. Additionally, the VPC is often accessible from anywhere with connection availability. Regardless, improvements to the conventional VPC network structures are desired to better satisfy issues discussed above.

### SUMMARY

The following summary is provided to merely introduce simplified concepts of the instant application, which concepts are further described below in the Detailed Description. This summary is not intended to identify essential features of the claimed subject matter, nor is it intended for use in determining the scope of the claimed subject matter.

The instant application discusses a networking method. The method may include receiving, at a first gateway hardware group, a data communication from a virtual machine (“VM”) in a first virtual private cloud (“VPC”). The data communication may include routing information for transmitting the data communication to a VM in a second VPC. The data communication may further be transmitted from the first gateway hardware group to a second gateway hardware group via a connection line having a globally unique identification (“ID”) assigned thereto. The second gateway hardware group may be distinct from the first gateway hardware group. Additionally, a portion of a total network traffic capacity of the connection line may be reserved for exclusive use of data transmissions being routed from the first VPC to the second VPC. Moreover, the data communication may be routed from the second gateway hardware group to the second VPC.

In addition, the instant application describes a networking system. The networking system may include a first gateway hardware group configured to receive a data communication from a virtual machine (“VM”) in a first virtual private cloud (“VPC”). The data communication may include routing information for transmitting the data communication to a VM in a second VPC. The networking system may further include a second gateway hardware group and a connection line. The second gateway hardware group may be configured to receive the data communication from the first gateway hardware group, and the second gateway hardware group may be distinct from the first gateway hardware group. The connection line may transmit data between the first gateway hardware group and the second gateway hardware group. Further, the connection line may have a globally unique identification (“ID”) assigned thereto. A portion of a total network traffic capacity of the connection line may be reserved for exclusive use of data transmissions being routed from the first VPC to the second VPC.

The instant application further describes a networking system including a plurality of distinct gateway hardware groups. A first gateway hardware group may be communicatively connected to a second gateway hardware group via a first connection line and communicatively connected to a third gateway hardware group via a second connection line. The second gateway hardware group may be communicatively connected to the third gateway hardware group via a third connection line. In some instances, the first gateway hardware group may be configured to receive a data communication from a virtual machine (“VM”) in a first virtual private cloud (“VPC”). The data communication may include routing information for transmitting the data communication to one of a VM in a second VPC or a VM in a third VPC. The second gateway hardware group may be configured to receive the data communication from the first gateway hardware group. The third gateway hardware group may also be configured to receive the data communication from the first gateway hardware group. Moreover, the first connection line, the second connection line, and the third connection line may each have a globally unique identification (“ID”) assigned thereto, respectively, and each supports transmission of layer 2 security protocol network traffic. A portion of a total network traffic capacity of each of the first connection line, the second connection line, and the third connection line may be reserved for exclusive use of data transmissions being routed between the first VPC, the second VPC, and the third VPC.

### BRIEF DESCRIPTION OF THE DRAWINGS

The Detailed Description is set forth with reference to the accompanying figures. In the figures, the left-most digit(s) of a reference number identifies the figure in which the reference number first appears. The use of the same reference numbers in different figures indicates similar or identical items.

FIG. 1 illustrates a network architecture of an end-user connecting to a VPC.

FIG. 2 illustrates additional detail of network architecture according to an example embodiment of this application.

FIG. 3 illustrates a method of networking according to an example embodiment of this application.

FIG. 4 illustrates a system according to an example embodiment of this application.

### DETAILED DESCRIPTION

### Overview

This disclosure is directed to providing an end-user with a secure and reliable connection between two or more distinct Virtual Private Cloud networks (“VPCs”). The end-users may be connecting to the one or more VPCs from an in-house or remote private or public network. Whether the end-user is accessing the VPCs from an in-house private network, or a remote public/private network is not of significance in this application. Thus, when the network from which the end-user is accessing the VPCs is discussed herein, that network is simply referred to as the end-user's originating network. Additionally, network traffic is used herein to describe all of the data transmissions occurring between any two routing points, (e.g., an end router, a personal user device, a unit of gateway hardware, an edge router, a gateway hardware group, a VPC, etc.)

In some instances, the VPCs may be made accessible to the end-user's originating network via a scalable system of gateway hardware, which may form a gateway hardware group, as discussed herein below. Furthermore, the network traffic may be transmitted from a cloud data center's edge router to gateway hardware in a VPC using Virtual Extensible Local Area Network (“VXLAN”) tunneling technology, or other tunneling technology. The tunneling technology may support layer 2 security protocol network traffic, as does VXLAN.

From a user's perspective, one potential difference of using VXLAN tunneling technology instead of conventional means may be noticed in data transmission consistency and speed of the connection due to reduced bottlenecking of data at the gateway hardware, where, in some instances, the gateway hardware may be part of a scalable gateway hardware group such as that described in U.S. application Ser. No. 15/005,613, which is incorporated in its entirety herein by reference. Visually, however, the actual means of access may be unknown to the user.

The basics of how an end-user might access a VPC may include the end-user setting up a connection from a private network on the end-user's premises to a service provider. The service provider may then set up a connection (e.g., physical connection or logical connection) using a Virtual Local Area Network (“VLAN”) with the customer switch (“CSW”) of a cloud data center service provider. The CSW is also referred to herein as the “edge router” of the cloud data center. Alternatively, the end-user may set up a direct connection to the edge router. At the edge router, an instance of Virtual Routing and Forwarding (“VRF”) is created for each end-user on the CSW. Next, using a Generic Routing Encapsulation (“GRE”) tunneling technology, or perhaps Internet Protocol Security (“IPsec technology”), a virtual machine (“VM”) instance gateway is created inside the VPC to connect a VPC with the VRF. Finally, the end-user network traffic is distributed to VMs in the VPCs via the VM gateway.

One example of the limitations of the above-described connection means includes the use of GRE and IPsec tunnels for connecting the user VRF to the VM gateway. Since GRE and IPsec tunnels are layer 3 over layer 3 tunneling protocols, such a network connection cannot support layer 2 based applications between the end-user's private network and the VPC. Furthermore, the use of a GRE or IPsec tunnel between the VRF and the VM gateway creates a problem that the traffic load for one end-user cannot be balanced in transmission between the VRF and the VM gateway. An additional limitation is that the gateway resides inside the VPC and the gateway is not a multi-user gateway. As such, the conventional means cannot leverage the possibility of allowing multiple end-users to share one gateway to reduce the cost and improve user satisfaction.

An alternative conventional means is simply connecting a private network entirely over the public internet, with or without an IPsec tunnel, to a VPC. However, low performance is often experienced due to unpredictable bandwidth and unreliable security, which creates a risk of compromised information.

Regardless of the manner in which an end-user connects to a first desired VPC, a situation may exist where an end-user desires to connect to multiple VPCs owned by the end-user, which VPCs are located in different regions or availability zones where, for example, different gateway hardware groups are tasked with forwarding the network traffic to the different VPCs, respectively. In such a situation, in accordance with the instant application, different VXLAN tunnels with different endpoints at the various VPCs and globally unique identifications are created to forward user traffic to different regions or availability zones.

VXLAN tunneling technology is implemented herein to peer across different regional VPCs because it is more effective in transmitting large amounts of network traffic that is balanced between the multiple gateway hardware server devices of the gateway hardware group. In particular, VXLAN tunneling technology handles layer 2 traffic and packages packet information via hardware encapsulation.

### Illustrative Embodiments of Network Architecture

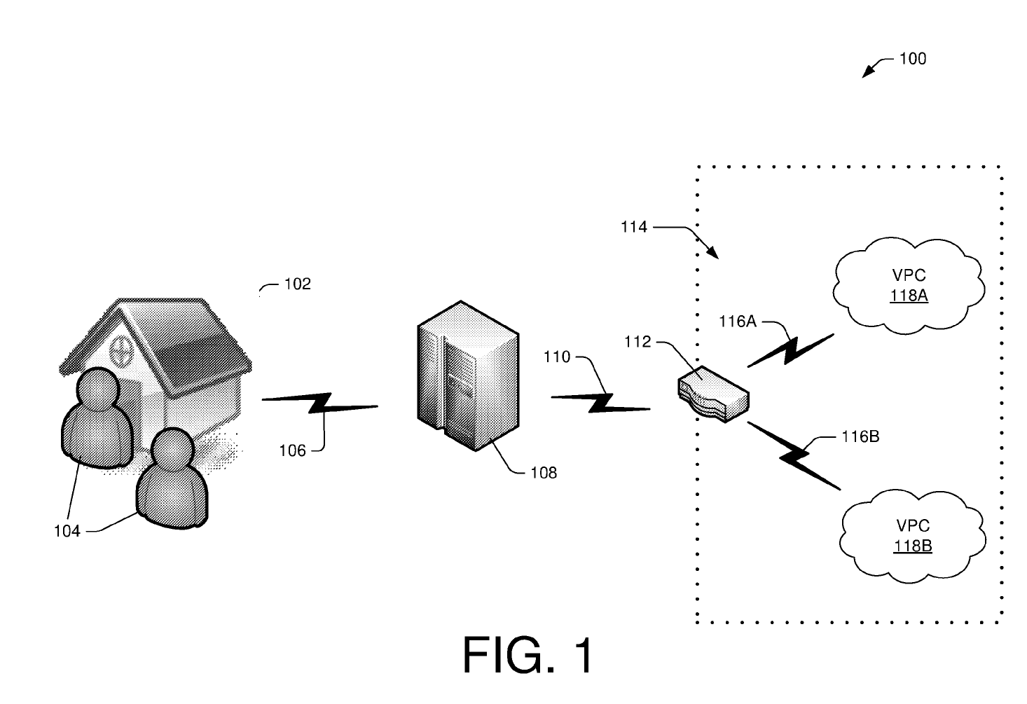

The network architecture 100 depicted in FIG. 1 includes a representation of a company 102 with end-users 104 using a private network connected to a virtual network. The company 102 may have IT needs that cannot be met easily within the company's available resources, or perhaps, the company 102 may prefer to rely on external IT support. To this end, the private network of company 102 may be connected via a connection 106 to a service provider 108. For added security, connection 106 may include a dedicated physical connection line. Additionally, even though a logical connection line may provide a less secure connection from the company 102 to the service provider 108, connection 106 may alternatively be a logical connection line.

In FIG. 1, service provider 108 is further directly connected via a connection 110 to an edge router 112 of a cloud data center 114. The direct connection 110 from the service provider 108 to the edge router 112 of the cloud data center 114 may be a dedicated physical connection line for greater security in protecting the transmission of the data of the private network. The edge router 112 may alternatively be referred to as a customer cloud access switch (“CSW”). In some instances, for a single end-user 104, a single instance of Virtual Routing and Forwarding (“VRF”) is created on the CSW. With this single instance of VRF, the end-user may connect to one or more VPCs, assuming each VPC belongs to the same end-user, regardless of the region in which the VPC is located.

In general, the network traffic of the private network is then routed from edge router 112 via a connection 116A, 116B to the appropriate VPC 118A, 118B. Each VPC 118A, 118B may be logically separated. However, in some instances, an end-user 104 may have prior rights/authorizations to be permitted to connect to both a first VPC 118A and a second VPC 118B, for example, where company 102 owns both VPC 118A and VPC 118B. The cloud data center 114 is discussed in greater detail herein below.

In one embodiment, connections 116A, 116B forward network traffic data from the edge router 112 to the VPCs 118A, 118B using VXLAN tunneling technology. VXLAN is used herein because of the superior technology compared to GRE tunneling technology, which cannot support layer 2 based applications between the end-users and the VPCs.

### Illustrative Embodiments of Cross-Regional Peering in a Cloud Data Center Network Infrastructure

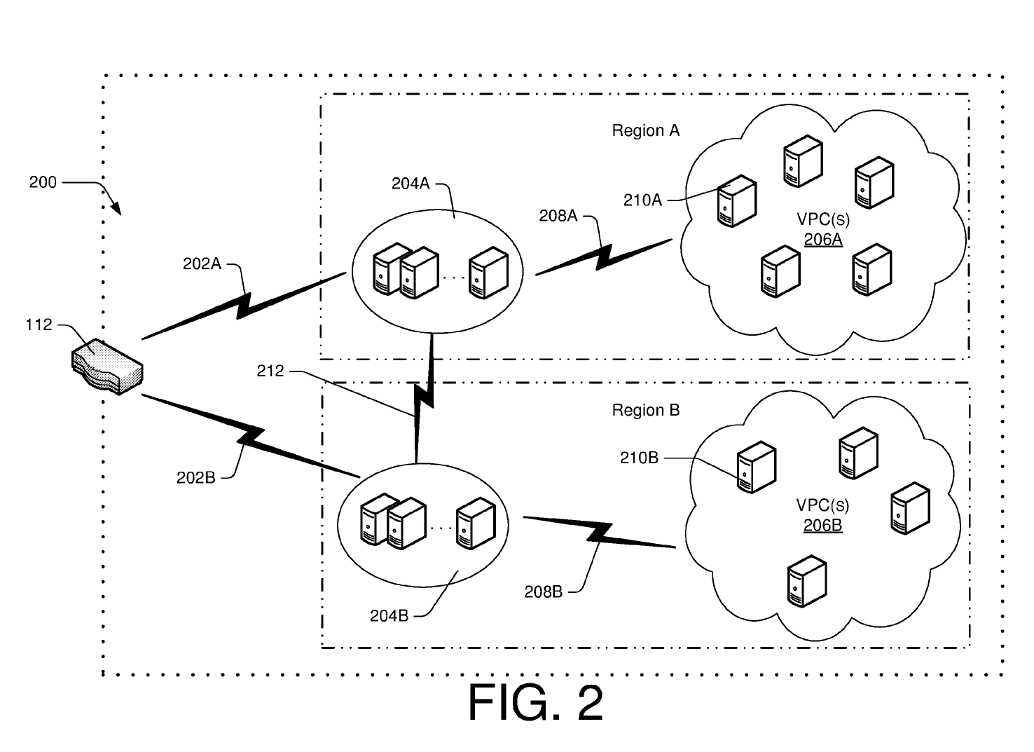

FIG. 2 depicts a situation where a cloud computing provider may manage a cloud data center 200 that includes VPCs across multiple geographic regions, such as Region A and Region B. An end-user (e.g., end-user 104 in FIG. 1) may desire to have data stored in a particular location, or the end-user may not have a preference at all, and the data may simply be stored in another non-local region (i.e., not local to the end-user relative to other available services) for purposes known to the provider. Regardless of the reason, a cloud computing provider may have multiple regions of service. In some instances, the regions A and B may be in different countries or operated by different regional service providers.

Similar to the access to the cloud data center 114 in FIG. 1, the cloud data center 200 is accessed via the edge router 112. From there, network traffic is routed via a connection 202A, 202B to the appropriate regional gateway hardware subgroup 204A, 204B, where the destination VPC(s) 206A, 206B is located. The connection 202A, 202B between edge router 112 and regional gateway hardware subgroup 204A, 204B, and connection 208A, 208B between regional gateway hardware subgroup 204A, 204B and VPC(s) 206A, 206B may be connection lines that implement VXLAN technology to reliably and securely transfer the network data. By using the VXLAN technology in combination with the load balancing, scalable gateway hardware group 204A, 204B, the end-user may be assured that the network communication between the private network and the VM(s) 210A, 210B of the VPC(s) 206A, 206B will not hit a bottleneck at the gateway. Note, however, that the end-user generally only pays for a predetermined amount of bandwidth. As such, it is possible that the end-user may try to transmit an amount of data that consumes more bandwidth than that for which the end-user pays. At such a point, the end-user would be restricted by a self-imposed limitation, but not by a limitation of the network's capabilities.

Moreover, the regional gateway hardware subgroups 204A and 204B in FIG. 2 may also be interconnected via a connection 212 such that an end-user may connect between distinct regional VPC(s) 206A and 206B, if desired when permitted. Connection 212 also may be a connection line that implements VXLAN technology to transfer the network data, so as to support layer 2 security protocol network traffic. In some instances, the connection line 212 may be assigned a globally unique identification (“ID”), such that any communications intended for cross-regional peering (for example, between VPC 206A and VPC 206B located in Regions A and B, respectively), may be quickly identified and routed between the VPCs 206A and 206B.

Thus, in some instances, the regional gateway hardware subgroup 204A may be configured to receive a data communication from one or more of the VMs 210A in the VPC 206A. The data communication is network data being communicated and transmitted in the network traffic, which originated from actions taken by the end-user accessing the VPC 206A. In a process of cross-region VPC peering, this data communication includes routing information for transmitting the data communication to the one or more VMs 210B in the VPC 206B. The routing information includes the end-destination and routing instructions to transmit via the connection line 212.

Prior to reaching the VPC 206B, the data communication is routed through the regional gateway hardware subgroup 204B. As such, the regional gateway hardware subgroup 204B is configured to receive the data communication from the regional gateway hardware subgroup 204A via the connection line 212. This transfer may occur directly and automatically because a portion of a total network traffic capacity of the connection line 212 may be reserved for exclusive use of data transmissions being routed from the VPC 206A to the VPC 206B. This reserved portion has the globally unique ID assigned to it specifically. The automatic routing occurs despite the regional gateway hardware subgroup 204B being distinct from the regional gateway hardware subgroup 204A because the routing information of the data communication includes the globally unique ID assigned to connection line 212.

### Illustrative Example of Connecting a Private Network to a VPC

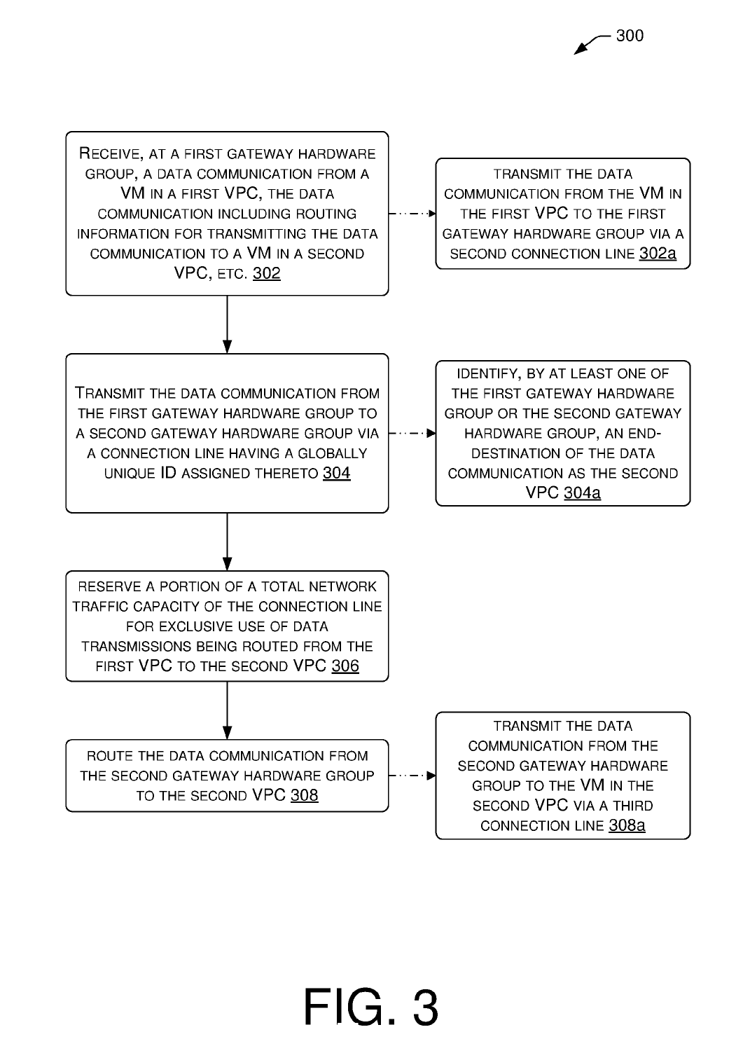

Method 300 of FIG. 3 describes a process of peering between two VPCs that are connected, at least in part, by a connection line (“a first connection line”) implementing VXLAN tunneling technology and having a globally unique ID. In step 302, a data communication may be received, at a first gateway hardware group (or subgroup), from a VM in a first VPC. The data communication includes routing information for transmitting the data communication to a VM in a second VPC, etc. In some instances, step 302 may further include a step 302a, in which the data communication is transmitted from the VM in the first VPC to the first gateway hardware group via a connection line (“a second connection line”). Further, VXLAN tunneling technology may be implemented for the first connection line and the second connection line.

For step 304, the data communication may be transmitted from the first gateway hardware group to a second gateway hardware group (or subgroup) via a connection line (“the first connection line”) having a globally unique identification (“ID”) assigned thereto. The second gateway hardware group is distinct from the first gateway hardware group. In some instances, step 304 may include, a step 304a, in which an end-destination of the data communication may be identified as the second VPC by at least one of the first gateway hardware group or the second gateway hardware group.

Step 306 includes reserving a portion of a total network traffic capacity of the connection line for exclusive use of data transmissions being routed from the first VPC to the second VPC.

Additionally, method 300 includes a step 308 of routing the data communication from the second gateway hardware group to the second VPC. Step 308 may further include step 308a, in which the data communication is transmitted from the second gateway hardware group to a VM in the second VPC via a connection line (“third connection line”). Further, as with the first connection line and the second connection line, VXLAN tunneling technology may be implemented for the third connection line.

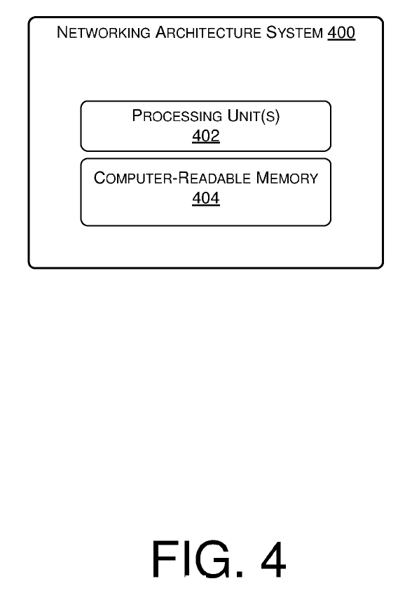

With respect to FIG. 4, the embodiments of the networking architecture system 400 described herein may be implemented via one or more processing units 402 based on instructions in computer-readable media 404, which may include, at least, two types of computer-readable media, namely computer storage media and communication media. Computer storage media may include volatile and non-volatile, non-transitory machine-readable, removable, and non-removable media implemented in any method or technology for storage of information (in compressed or uncompressed form), such as computer (or other electronic device) readable instructions, data structures, program modules, or other data to perform processes or methods described herein. Computer storage media includes, but is not limited to hard drives, floppy diskettes, optical disks, CD-ROMs, DVDs, read-only memories (ROMs), random access memories (RAMs), EPROMs, EEPROMs, flash memory, magnetic or optical cards, solid-state memory devices, or other types of media/machine-readable medium suitable for storing electronic instructions.

### CONCLUSION

Although several embodiments have been described in language specific to structural features and/or methodological acts, it is to be understood that the claims are not necessarily limited to the specific features or acts described. Rather, the specific features and acts are disclosed as illustrative forms of implementing the claimed subject matter.

All of the methods and processes described above may be embodied in, and fully automated via, software code modules executed by one or more general purpose computers or processors. The code modules may be stored in any type of computer-readable storage medium or other computer storage device. Some or all of the methods may alternatively be embodied in specialized computer hardware.

What is claimed is:

1. A networking method, comprising steps of:
receiving, at a first gateway hardware group, a data communication from a virtual machine (“VM”) in a first virtual private cloud (“VPC”), the data communication including routing information for transmitting the data communication to a VM in a second VPC;
transmitting the data communication from the first gateway hardware group to a second gateway hardware group via a connection line having a globally unique identification (“ID”) assigned thereto, the second gateway hardware group being distinct from the first gateway hardware group;
reserving a portion of a total network traffic capacity of the connection line for exclusive use of data transmissions being routed from the first VPC to the second VPC; and
routing the data communication from the second gateway hardware group to the second VPC.

2. The networking method according to claim 1, wherein the transmitting includes identifying, by at least one of the first gateway hardware group or the second gateway hardware group, an end-destination of the data communication as the second VPC.

3. The networking method according to claim 1, further comprising implementing Virtual Extensible Local Area Network (“VXLAN”) technology for the connection line.

4. The networking method according to claim 1, wherein the first VPC is located in a first geographical region, and the second VPC is located in a second geographical region.

5. The networking method according to claim 4, wherein the first VPC is hosted by a first service provider, and the second VPC is hosted by a second service provider different than the first service provider.

6. The networking method according to claim 4, wherein the first geographical region is in a first country, and the second service provider is in a second country distinct from the first country.

7. The networking method according to claim 1, wherein the connection line is a first connection line,
wherein the receiving includes transmitting the data communication from the VM in the first VPC to the first gateway hardware group via a second connection line, and
wherein Virtual Extensible Local Area Network (“VXLAN”) technology is implemented for the first connection line and the second connection line.

8. The networking method according to claim 7, wherein the routing includes transmitting the data communication from the second gateway hardware group to the VM in the second VPC via a third connection line, and
wherein VXLAN technology is implemented for the third connection line.

9. The networking method according to claim 1, wherein the connection line supports layer 2 security protocol network traffic.

10. A networking system, comprising:
a first gateway hardware group configured to receive a data communication from a virtual machine (“VM”) in a first virtual private cloud (“VPC”), the data communication including routing information for transmitting the data communication to a VM in a second VPC;
a second gateway hardware group configured to receive the data communication from the first gateway hardware group, the second gateway hardware group being distinct from the first gateway hardware group; and
a connection line that transmits data between the first gateway hardware group and the second gateway hardware group, the connection line having a globally unique identification (“ID”) assigned thereto, and a portion of a total network traffic capacity of the connection line being reserved for exclusive use of data transmissions being routed from the first VPC to the second VPC.

11. The networking system according to claim 10, wherein, in response to receipt of the data communication from the VM in the first VPC, the first gateway hardware group determines an end-destination of the data communication, and
wherein, upon a determination that the end-destination is the second VPC, the first gateway hardware group routes the data communication to the second gateway hardware group.

12. The networking system according to claim 10, wherein the connection line uses Virtual Extensible Local Area Network (“VXLAN”) technology.

13. The networking system according to claim 10, wherein the first VPC is located in a first geographical region, and the second VPC is located in a second geographical region.

14. The networking system according to claim 13, wherein the first VPC is hosted by a first service provider, and the second VPC is hosted by a second service provider different than the first service provider.

15. The networking method according to claim 13, wherein the first geographical region is in a first country, and the second service provider is in a second country distinct from the first country.

16. The networking method according to claim 10, wherein the connection line is a first connection line,
wherein the system further comprises a second connection line via which the data communication is transmitted from the VM in the first VPC to the first gateway hardware group, and
wherein the first connection line and the second connection line use Virtual Extensible Local Area Network (“VXLAN”) technology for data transmission.

17. The networking system according to claim 16, further comprising a third connection line via which the data transmission is transmitted from the second gateway hardware group to the VM in the second VPC via a third connection line, and
wherein the third connection line uses VXLAN technology.

18. The networking system according to claim 10, wherein the connection line supports layer 2 security protocol network traffic.

19. A networking system, comprising:
a plurality of distinct gateway hardware groups including a first gateway hardware group communicatively connected to a second gateway hardware group via a first connection line and communicatively connected to a third gateway hardware group via a second connection line, the second gateway hardware group being communicatively connected to the third gateway hardware group via a third connection line,
wherein the first gateway hardware group is configured to receive a data communication from a virtual machine (“VM”) in a first virtual private cloud (“VPC”), the data communication including routing information for transmitting the data communication to one of a VM in a second VPC or a VM in a third VPC,
wherein the second gateway hardware group is configured to receive the data communication from the first gateway hardware group,
wherein the third gateway hardware group is configured to receive the data communication from the first gateway hardware group, and
wherein the first connection line, the second connection line, and the third connection line each have a globally unique identification (“ID”) assigned thereto, respectively, and each supports transmission of layer 2 security protocol network traffic, and a portion of a total network traffic capacity of each of the first connection line, the second connection line, and the third connection line being reserved for exclusive use of data transmissions being routed between the first VPC, the second VPC, and the third VPC.

20. The networking system according to claim 19, wherein at least one of the first gateway hardware group, the second gateway hardware group, or the third gateway hardware group includes a plurality of interconnected gateway hardware devices.

21. One or more computer-readable media having instructions, which when executed, cause one or more processing units to perform acts, comprising:
receiving, at a first gateway hardware group, a data communication from a virtual machine (“VM”) in a first virtual private cloud (“VPC”), the data communication including routing information for transmitting the data communication to a VM in a second VPC;
transmitting the data communication from the first gateway hardware group to a second gateway hardware group via a connection line having a globally unique identification (“ID”) assigned thereto, the second gateway hardware group being distinct from the first gateway hardware group;
reserving a portion of a total network traffic capacity of the connection line for exclusive use of data transmissions being routed from the first VPC to the second VPC; and
routing the data communication from the second gateway hardware group to the second VPC.

22. The one or more computer-readable media according to claim 21, wherein the transmitting includes identifying, by at least one of the first gateway hardware group or the second gateway hardware group, an end-destination of the data communication as the second VPC.

23. The one or more computer-readable media according to claim 21, wherein the acts further include implementing Virtual Extensible Local Area Network (“VXLAN”) technology for the connection line.
